(19) United States
(12) Patent Application Publication
(10) Pub. No.: US 2024/0320302 A1
(43) Pub. Date: Sep. 26, 2024

(54) CHANGE DETECTING DEVICE AND CHANGE DETECTING METHOD

(71) Applicants: AZBIL KIMMON CO., LTD., Tokyo (JP); National University Corporation Yamagata University, Yamagata-shi (JP)

(72) Inventors: Eiji MURAKAMI, Tokyo (JP); Ikumi Suzuki, Takizawa (JP); Kazuo Hara, Yamagata-shi (JP)

(73) Assignees: AZBIL KIMMON CO., LTD., Tokyo (JP); National University Corporation Yamagata University, Yamagata-shi (JP)

(21) Appl. No.: 18/608,364

(22) Filed: Mar. 18, 2024

(30) Foreign Application Priority Data
Mar. 23, 2023 (JP) 2023-046097

(51) Int. Cl. G06F 17/17

(52) U.S. Cl. CPC G06F 17/17

(57) ABSTRACT

A change detecting device includes: a time-series data acquiring unit that acquires time-series data in a period including a first period and a second period after the first period; a vector acquiring unit that acquires first vectors which are pieces of partial time-series data in the first period and second vectors which are pieces of partial time-series data in the second period on the basis of the time-series data acquired by the time-series data acquiring unit; a difference vector acquiring unit that acquires a difference vector related to a combination of a specific first vector among the first vectors and a specific second vector among the second vectors in a plurality of combinations; and a change detecting unit that detects a characteristic change of the time-series data on the basis of a bias in distribution of directions of the plurality of difference vectors acquired by the difference vector acquiring unit.

### TECHNICAL FIELD

The present disclosure relates to a change detecting device and a change detecting method.

### BACKGROUND ART

Conventionally, a RuLSIF method has been disclosed as a method for detecting a characteristic change of time-series data (see Non-Patent Literature 1). The method described in Non-Patent Literature 1 is a method for acquiring time-series data in a predetermined period and time-series data in a period after the predetermined period, and determining whether or not a characteristic change of the time-series data has occurred on the basis of a density ratio of a probability distribution of the time-series data in each of the periods.

### CITATION LIST

### Non-Patent Literature

Non-Patent Literature 1: S. Liu, M. Yamada, N. Collier, and M. Sugiyama, Change-point detection in time-series data by relative density-ratio estimation, Neural Networks, 43(2013), pp. 72-83.

### SUMMARY OF INVENTION

### Technical Problem

In general, time-series data may include an outlier which is significantly different from another data value due to various factors. However, in the method described in Non-Patent Literature 1, calculation of the density ratio is affected by an outlier included in the time-series data, and thus has a problem that accuracy in detecting a characteristic change may be reduced depending on the outlier included in the time-series data.

The present disclosure has solved the above problem, and an object of the present disclosure is to provide a change detecting device and a change detecting method capable of improving accuracy in detecting a characteristic change of time-series data as compared with related art.

### Solution to Problem

A change detecting device according to the present disclosure includes: a time-series data acquiring unit to acquire time-series data in a period including a first period and a second period which is a period after the first period; a vector acquiring unit to acquire a plurality of first vectors which are a plurality of pieces of partial time-series data in the first period and a plurality of second vectors which are a plurality of pieces of partial time-series data in the second period on the basis of the time-series data acquired by the time-series data acquiring unit; a difference vector acquiring unit to acquire a difference vector related to a combination of a specific first vector among the plurality of first vectors and a specific second vector among the plurality of second vectors in a plurality of combinations; and a change detecting unit to detect a characteristic change of the time-series data on the basis of a bias in distribution of directions of the plurality of difference vectors acquired by the difference vector acquiring unit.

### Advantageous Effects of Invention

According to the present disclosure, it is possible to suppress an influence of an outlier included in time-series data by detecting a characteristic change of the time-series data on the basis of a bias in directions of a plurality of difference vectors acquired from a first vector which is partial time-series data in a first period and a second vector which is partial time-series data in a second period of the time-series data, and thus it is possible to improve accuracy in detecting the characteristic change of the time-series data as compared with related art.

### BRIEF DESCRIPTION OF DRAWINGS

FIG. 1 is a block diagram illustrating a schematic configuration of a change detecting device according to a first embodiment.

FIG. 2 is a block diagram illustrating an example of a hardware configuration of the change detecting device according to the first embodiment.

FIG. 3 is a block diagram illustrating an example of the hardware configuration of the change detecting device according to the first embodiment.

FIG. 4 is a flowchart illustrating processes performed by the change detecting device according to the first embodiment.

FIG. 5 is a graph illustrating an example of time-series data acquired by the change detecting device according to the first embodiment.

FIG. 6 is a conceptual diagram illustrating an example of a vector acquiring process performed by the change detecting device according to the first embodiment.

FIG. 7 is a diagram illustrating a plurality of first vectors and a plurality of second vectors obtained by the vector acquiring process performed by the change detecting device according to the first embodiment.

FIG. 8A is a conceptual diagram illustrating a first difference vector acquiring process performed by the change detecting device according to the first embodiment, FIG. 8B is a diagram illustrating an example of a plurality of first difference vectors obtained by the first difference vector acquiring process performed by the change detecting device according to the first embodiment, and FIG. 8C is a diagram illustrating an example of a plurality of first residual normalized vectors obtained by a first normalization process performed by the change detecting device according to the first embodiment.

FIG. 9A is a conceptual diagram illustrating the first difference vector acquiring process performed by the change detecting device according to the first embodiment, FIG. 9B is a diagram illustrating an example of the plurality of first difference vectors obtained by the first difference vector acquiring process performed by the change detecting device according to the first embodiment, and FIG. 9C is a diagram illustrating an example of the plurality of first residual normalized vectors obtained by the first normalization process performed by the change detecting device according to the first embodiment.

FIG. 10A is a conceptual diagram illustrating the first difference vector acquiring process performed by the change detecting device according to the first embodiment, FIG. 10B is a diagram illustrating an example of the plurality of first difference vectors obtained by the first difference vector acquiring process performed by the change detecting device according to the first embodiment, and FIG. 10C is a diagram illustrating an example of the plurality of first residual normalized vectors obtained by the first normalization process performed by the change detecting device according to the first embodiment.

FIG. 11A is a conceptual diagram illustrating a second difference vector acquiring process performed by the change detecting device according to the first embodiment, FIG. 11B is a diagram illustrating an example of a plurality of second difference vectors obtained by the second difference vector acquiring process performed by the change detecting device according to the first embodiment, and FIG. 11C is a diagram illustrating an example of a plurality of second residual normalized vectors obtained by a second normalization process performed by the change detecting device according to the first embodiment.

FIG. 12 is a conceptual diagram illustrating the vector acquiring process performed by the change detecting device according to the first embodiment.

FIG. 13 is a schematic diagram illustrating a timing gear of which a change of vibration is detected by the change detecting device according to the first embodiment.

FIG. 14A is a graph illustrating vibration data of a timing gear as time-series data acquired by the change detecting device according to the first embodiment, and FIG. 14B is a graph illustrating a change score calculated by the change detecting device according to the first embodiment on the basis of the vibration data of the timing gear.

FIG. 15 is a graph illustrating gas consumption amount data as time-series data acquired by the change detecting device according to the first embodiment and a change score calculated on the basis of the gas consumption amount data.

FIG. 16A is a graph illustrating a transition of a daily closing price of a TSE stock price index as time-series data acquired by the change detecting device according to the first embodiment, and FIG. 16B is a graph illustrating a change score calculated by the change detecting device according to the first embodiment on the basis of data of the TSE stock price index.

### DESCRIPTION OF EMBODIMENTS

Hereinafter, an embodiment according to the present disclosure will be described in detail with reference to the drawings.

### First Embodiment

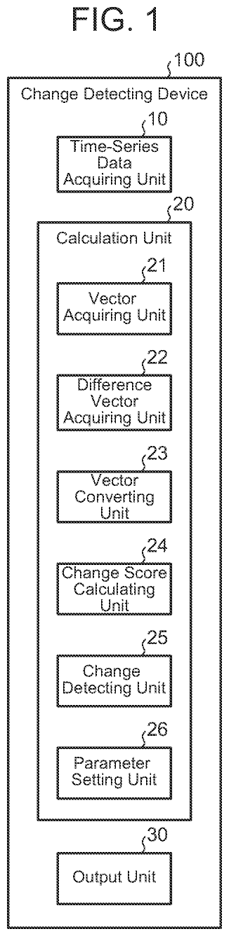

First, a schematic configuration of a change detecting device 100 according to a first embodiment will be described with reference to FIG. 1. FIG. 1 is a block diagram illustrating a schematic configuration of the change detecting device 100 according to the first embodiment. As illustrated in FIG. 1, the change detecting device 100 according to the first embodiment includes a time-series data acquiring unit 10 that acquires time-series data, a calculation unit 20 that performs calculation on the basis of the time-series data acquired by the time-series data acquiring unit 10, and an output unit 30 that outputs a result of the calculation by the calculation unit 20.

The time-series data acquiring unit 10 acquires time-series data that causes the change detecting device 100 to determine presence or absence of a characteristic change. For example, the time-series data acquiring unit 10 acquires time-series data from an input device (not illustrated) that receives an input operation by a user, a storage device (not illustrated) included in the change detecting device 100, an external device (not illustrated) communicably connected to the change detecting device 100, such as a sensor or a computer, an external storage medium read by an information reading device (not illustrated) included in the change detecting device 100, or the like. Note that the time-series data acquired by the time-series data acquiring unit 10 is not limited to series data including a value indicating time. The time-series data acquired by the time-series data acquiring unit 10 only needs to be series data including a value related to time, and for example, may be series data including a value indicating an elapsed time starting from a specific time, or may be series data including a value other than a value directly indicating time, such as the number of counts increasing in number as time advances.

The calculation unit 20 includes a vector acquiring unit 21, a difference vector acquiring unit 22, a vector converting unit 23, a change score calculating unit 24, a change detecting unit 25, and a parameter setting unit 26, and detects a characteristic change of time-series data on the basis of the time-series data acquired by the time-series data acquiring unit 10.

The vector acquiring unit 21 acquires a plurality of first vectors which are a plurality of pieces of partial time-series data in a first period on the basis of the time-series data acquired by the time-series data acquiring unit 10. In other words, the vector acquiring unit 21 extracts a plurality of pieces of partial time-series data as a plurality of first vectors from the time-series data in the first period within the time-series data acquired by the time-series data acquiring unit 10. Note that the partial time-series data is series data obtained by combining a plurality of consecutive data values among data values included in the time-series data.

In addition, the vector acquiring unit 21 acquires a plurality of second vectors which are a plurality of pieces of partial time-series data in a second period which is a period after the first period on the basis of the time-series data acquired by the time-series data acquiring unit 10. In other words, the vector acquiring unit 21 extracts a plurality of pieces of partial time-series data as a plurality of second vectors from time-series data in a second period which is a period after the first period within the time-series data acquired by the time-series data acquiring unit 10. Note that a start point of the second period may be temporally separated from an end point of the first period, but is desirably not a time before the end point of the first period.

The difference vector acquiring unit 22 acquires a difference vector between a specific first vector among the plurality of first vectors and a specific second vector among the plurality of second vectors. In addition, the difference vector acquiring unit 22 acquires a plurality of difference vectors by performing acquirement of the difference vector in a plurality of combinations of the first vectors and the second vectors.

The vector converting unit 23 normalizes each of the plurality of difference vectors acquired by difference vector acquiring unit 22. In other words, the vector converting unit 23 converts each of the plurality of difference vectors acquired by the difference vector acquiring unit 22 into a residual normalized vector having a size of 1. Note that the vector converting unit 23 only needs to be configured to acquire vectors obtained by converting the plurality of difference vectors acquired by the difference vector acquiring unit 22 in such a way as to have a uniform size without changing directions of the difference vectors. For example, the vector converting unit may be configured to convert each of the plurality of difference vectors acquired by the difference vector acquiring unit 22 into a vector having a size other than 1.

The change score calculating unit 24 calculates a change score on the basis of the plurality of residual normalized vectors obtained by the conversion of the vector converting unit 23. The change score is a value indicating a bias in distribution of directions of the plurality of residual normalized vectors obtained by the conversion of the vector converting unit 23. For example, when a trend of the time-series data changes, directions of the plurality of difference vectors acquired by the difference vector acquiring unit 22 are likely to be biased. Therefore, it is possible to detect a characteristic change of the time-series data on the basis of a bias in distribution of directions of the plurality of difference vectors acquired by the difference vector acquiring unit 22.

However, such a plurality of difference vectors may include an outlier difference vector calculated on the basis of an outlier of the time-series data, and the outlier difference vector is calculated as a vector larger than other difference vectors. As a result, detection accuracy may be affected depending on a detection method when a characteristic change of the time-series data is detected. Therefore, in order to focus only on directions of the plurality of difference vectors acquired by the difference vector acquiring unit 22, the change detecting device 100 according to the first embodiment is configured to convert the plurality of difference vectors into residual normalized vectors having a size of 1 and then to detect a characteristic change of the time-series data on the basis of a bias in distribution of the plurality of residual normalized vectors.

The change detecting unit 25 detects a characteristic change of the time-series data by determining whether or not there is a characteristic change between the time-series data in the first period and the time-series data in the second period on the basis of the calculation result by the change score calculating unit 24. For example, the change detecting unit 25 determines whether or not there is a characteristic change of the time-series data by comparing the change score calculated by the change score calculating unit 24 with a threshold set in advance. As described above, the change detecting unit 25 detects a characteristic change of the time-series data on the basis of a bias in distribution of directions of the plurality of difference vectors acquired by the difference vector acquiring unit 22.

The parameter setting unit 26 sets various parameters to be performed by the calculation unit 20. For example, the parameter setting unit 26 sets various parameters on the basis of information from an input device (not illustrated) that receives an input operation by a user, a storage device (not illustrated) included in the change detecting device 100, an external device (not illustrated) communicably connected to the change detecting device 100, an external storage medium read by an information reading device (not illustrated) included in the change detecting device 100, or the like. In addition, the parameter setting unit 26 sets various parameters on the basis of the time-series data acquired by the time-series data acquiring unit 10. For example, the parameter setting unit 26 sets parameters such as the size of the partial time-series data (the number of dimensions of a vector) acquired by the vector acquiring unit 21, a time difference between the pieces of partial time-series data acquired by the vector acquiring unit 21, and a threshold used for determination by the change detecting unit 25.

The output unit 30 outputs a detection result by the change detecting unit 25. In other words, the output unit 30 outputs information indicating whether or not there is a characteristic change of the time-series data by the change detecting unit 25. For example, the output unit 30 outputs a detection result by the change detecting unit 25 to a display device (not illustrated) that displays information, a storage device (not illustrated) included in the change detecting device 100, an external device (not illustrated) communicably connected to the change detecting device 100, an external storage medium into which information is written by an information reading device (not illustrated) included in the change detecting device 100, or the like.

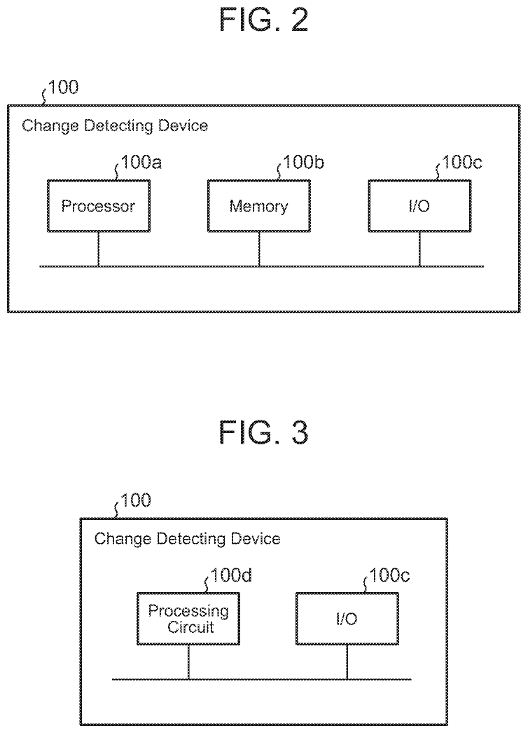

Next, a hardware configuration of the change detecting device 100 will be described with reference to FIGS. 2 and 3. FIG. 2 is a diagram illustrating an example of the hardware configuration of the change detecting device 100 in the first embodiment, and FIG. 3 is a diagram illustrating another example of the hardware configuration of the change detecting device 100 in the first embodiment. For example, as illustrated in FIG. 2, the change detecting device 100 includes a processor 100a, a memory 100b, and an I/O port 100c, and is configured in such a manner that the processor 100a reads and executes a program stored in the memory 100b.

In addition, for example, as illustrated in FIG. 3, the change detecting device 100 includes a processing circuit 100d and an I/O port 100c which are dedicated hardware. The processing circuit 100d is constituted by, for example, a single circuit, a composite circuit, a programmed processor, a parallel programmed processor, a system large-scale integration (LSI), an application specific integrated circuit (ASIC), a field programmable gate array (FPGA), or a combination thereof. Functions of the change detecting device 100 are implemented as a result of the processor 100a or the processing circuit 100d as dedicated hardware executing a program as software. Note that the change detecting device 100 may include hardware (not illustrated) other than the above.

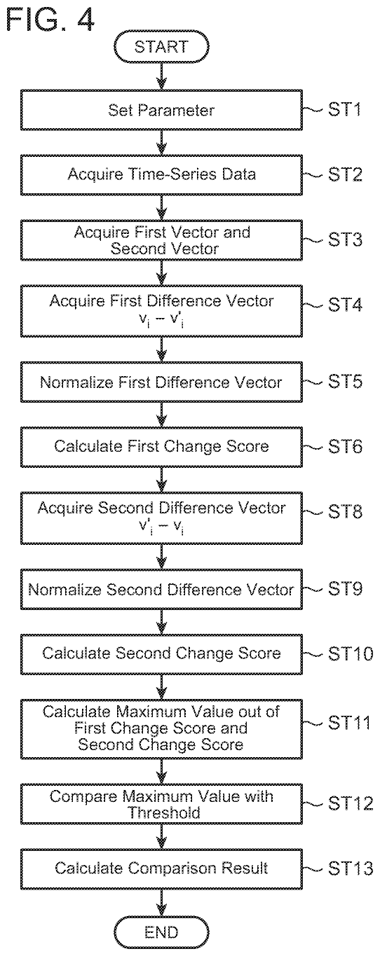

Next, processes performed by the change detecting device 100 according to the first embodiment will be described with reference to FIGS. 4 to 12. FIG. 4 is a flowchart illustrating processes performed by the change detecting device 100 according to the first embodiment. First, when starting the processes, the change detecting device 100 performs a parameter setting process of setting various parameters (step ST1). In this process, the change detecting device 100 sets the various parameters for the calculation unit 20 to perform calculation by the parameter setting unit 26. After performing the process in step ST1, the change detecting device 100 performs a time-series data acquiring process of acquiring time-series data (step ST2). In this process, the change detecting device 100 acquires the time-series data by the time-series data acquiring unit 10.

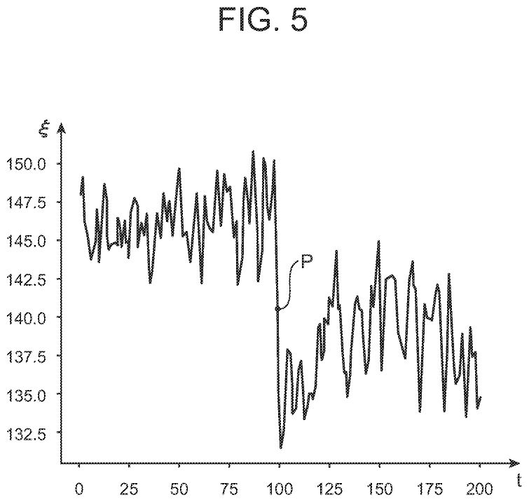

FIG. 5 is a graph illustrating an example of the time-series data acquired by the change detecting device 100 according to the first embodiment. The time-series data illustrated in FIG. 5 is time-series data having two variables including a time t and a data value ξ. For example, when determining whether or not there is a characteristic change before and after time t=100 in the time-series data illustrated in FIG. 5, the change detecting device 100 acquires, within the time-series data, first time-series data in a first period which is a period before time t=100 and second time-series data in a second period which is a period after time t=100. In other words, within the acquired time-series data, the change detecting device 100 acquires time-series data before a point P which is data at time t=100 as the first time-series data, and acquires data after the point P as the second time-series data.

After performing the process in step ST2, the change detecting device 100 performs a vector acquiring process of acquiring a plurality of first vectors on the basis of the first time-series data and acquiring a plurality of second vectors on the basis of the second time-series data (step ST3). In this process, the change detecting device 100 acquires a plurality of first vectors which are partial time-series data of the first time-series data and a plurality of second vectors which are partial time-series data of the second time-series data by the vector acquiring unit 21.

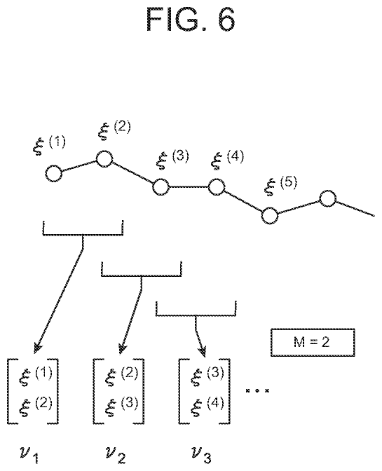

FIG. 6 is a conceptual diagram illustrating an example of a vector acquiring process performed by the change detecting device according to the first embodiment. For example, the change detecting device 100 extracts, within the first time-series data, partial time-series data including a specific data valueξ(1) and a data value ξ(2) which is data adjacent to ξ(1) on a side later in time than § (1) as [§ (1), § (2)] which is a first vector. Note that the numerical value of the shoulder of & indicates time. Similarly, the change detecting device 100 extracts, within the first time-series data, partial time-series data including the specific data value ξ(2) and a data value ξ(3) which is data adjacent to ξ(2) on a side later in time than ξ(2) as [ξ(2), ξ(3)] which is a first vector. Thereafter, adjacent data values are sequentially extracted as a first vector which is partial time-series data, and a plurality of first vectors is acquired.

In other words, in the process in step ST3, the change detecting device 100 extracts, within the first time-series data, M adjacent data values as a first vector having the number of dimensions of M, and sequentially slides the times of the extracted data values by the number of slides of a slide window, thereby converting the first time-series data into a set of a plurality of first vectors. In the example of FIG. 6, the change detecting device 100 performs a process with the number of dimensions M of the first vector, which is the size of the window, being 2 and the number of slides of the data value being 1.

Next, the change detecting device 100 extracts, within the second time-series data, M adjacent data values as a second vector having the number of dimensions of M, and sequentially slides the times of the extracted data values by the number of slides of a slide window, thereby converting the second time-series data into a set of a plurality of second vectors. Note that the value of the number of dimensions M of each of the first vector and the second vector set as a parameter can be set to any integer equal to or more than 2, and the value of the number of slides of the data value can be set to any value. However, the value of M and the value of the number of slides of the data value are desirably the same between the process of converting the first time-series data into a plurality of first vectors and the process of converting the second time-series data into a plurality of second vectors.

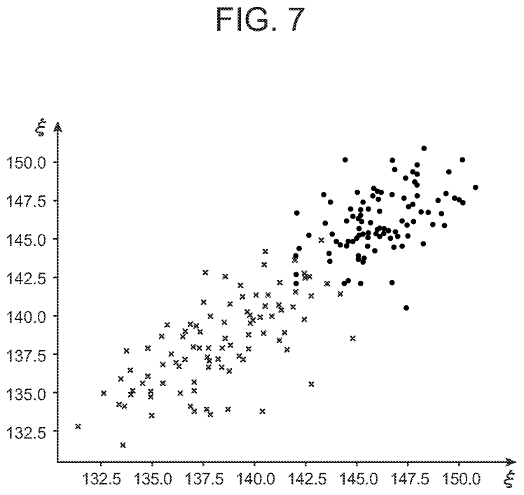

FIG. 7 is a diagram illustrating the plurality of first vectors and the plurality of second vectors obtained by the vector acquiring process performed by the change detecting device 100 according to the first embodiment. In FIG. 7, a circle indicates the first vector, and X indicates the second vector. In the vector acquiring process in step ST3, the number of dimensions M of each of the first vector and the second vector is 2, and therefore the first vector and the second vector are indicated on the two-dimensional plane illustrated in FIG. 7.

After performing the process in step ST3, the change detecting device 100 performs a first difference vector acquiring process of calculating a difference vector between the first vector and the second vector acquired in the vector acquiring process in step ST3 (step ST4). In the first difference vector acquiring process as the difference vector acquiring process, the change detecting device 100 subtracts a specific second vector v′ᵢ among the plurality of second vectors from a specific first vector vᵢ among the plurality of first vectors by the difference vector acquiring unit 22, and calculates a first difference vector rᵢ.

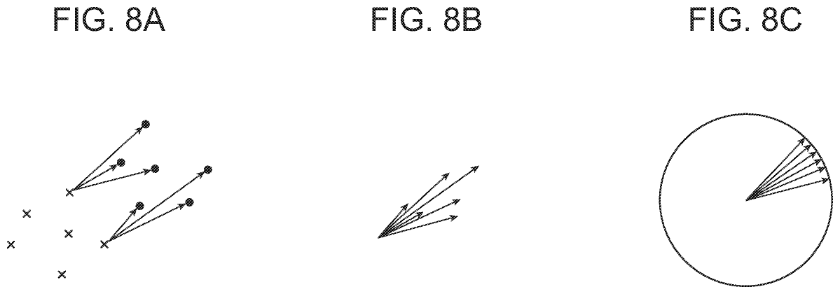

FIG. 8A is a conceptual diagram illustrating the first difference vector acquiring process performed by the change detecting device 100 according to the first embodiment. In FIG. 8A, a circle indicates a first vector, and X indicates a second vector. For example, in the first difference vector acquiring process, the change detecting device 100 performs, for each second vector, a process of extracting a first vector vᵢ closest to a specific second vector v′ᵢ by a k-nearest neighbor algorithm (knn) which is a known algorithm, and as expressed by Numerical Formula (1), subtracting the corresponding second vector v′ᵢ from the extracted first vector vᵢ, and calculates a first difference vector rᵢ, thereby acquiring a plurality of first difference vectors. Note that, in a case where k in the k-nearest neighbor algorithm is equal to or more than 2, the difference vector rᵢ is calculated using v′ᵢ^{(knn)} which is an average vector of vectors that are k-nearest neighbors.

$${r}_{i} = {v}_{i} - {v}_{i}^{′ ( knn )} ( i = 1 , 2 , … , n ) \qquad ( 1 )$$

$$Here , {v}_{i}^{′ ( knn )} = \frac{1}{k} {\sum }_{j = 1}^{k} {v}_{i}^{′ ( j )}$$

FIG. 8B is a diagram illustrating an example of the plurality of first difference vectors obtained by the first difference vector acquiring process performed by the change detecting device 100 according to the first embodiment. Naturally, the plurality of first difference vectors obtained by the first difference vector acquiring process in step ST4 have different directions and sizes.

After performing the process in step ST4, the change detecting device 100 performs a first normalization process of normalizing each of the first difference vectors rᵢ calculated in the first difference vector acquiring process in step ST4 (step ST5). In the first normalization process as a normalization process, the change detecting device 100 acquires first residual normalized vectors as a plurality of residual normalized vectors by converting each of the first difference vectors rᵢ into a corresponding one of the first residual normalized vector zᵢ by the vector converting unit 23 as illustrated in Numerical Formula (2). In other words, the change detecting device 100 converts each of the first difference vectors in such a manner that the size of each of the first difference vectors is 1 by the first normalization process. Further, in other words, the change detecting device 100 makes the sizes of the first difference vectors uniform by the first normalization process.

$${z}_{i} = {r}_{i} / ‖ {r}_{i} ‖ ( i = 1 , 2 , … , n ) \qquad ( 2 )$$

FIG. 8C is a diagram illustrating an example of the plurality of first residual normalized vectors obtained by the first normalization process performed by the change detecting device 100 according to the first embodiment. The change detecting device 100 converts a plurality of first difference vectors having the number of dimensions M of 2 into a plurality of first residual normalized vectors having the number of dimensions M of 2 by the first normalization process. The plurality of first residual normalized vectors are distributed on a circumference having a radius of 1. Note that in a case where the number of dimensions M is 3, the plurality of first residual normalized vectors are distributed on a spherical surface, and in a case where the number of dimensions M is equal to or more than 4, the plurality of first residual normalized vectors are distributed on a hyperspherical surface.

After performing the process in step ST5, the change detecting device 100 performs a first change score calculating process of calculating a first change score on the basis of the plurality of first residual normalized vectors (step ST6). In the first change score calculating process as a change score calculating process, the change detecting device 100 calculates and acquires the first change score which is a value indicating a bias of distribution of the plurality of first residual normalized vectors by the change score calculating unit 24.

For example, as illustrated in Numerical Formula (3), the change detecting device 100 calculates a Rayleigh score R as the first change score by a known algorithm.

$$R = ‖ {\sum }_{i = 1}^{n} {Z}_{i} ‖ \qquad ( 3 )$$

$$( i = 1 , 2 , … , n )$$

The Rayleigh score R is a value close to zero in a case where distribution of the plurality of first residual normalized vectors zᵢ is uniform on a circumference, a spherical surface, or a hyperspherical surface, and is a large value in a case where the distribution is biased. Therefore, by evaluating the size of the Rayleigh score, it is possible to determine whether or not there is a characteristic change of the time-series data. Note that the change score calculated by the change score calculating unit 24 only needs to be a value corresponding to a bias (uniformity) of the distribution of the plurality of first residual normalized vectors, and may be, for example, a Gine score or an Ajne score obtained by a known algorithm.

It is assumed that i and j are indexes of the first residual normalized vector, and zᵢ and zⱼ are two first residual normalized vectors. At this time, the Gine score Fₙ and the Ajne score Aₙ are expressed by the following Numerical Formulas (4) and (5), respectively.

$${F}_{n} = \frac{3 n}{2} - \frac{4}{n π} {\sum }_{i < j} ( {Ψ}_{ij} + sin {Ψ}_{ij} ) \qquad ( 4 )$$

$$Here , {Ψ}_{ij} = {cos}^{- 1} ( {z}_{i}^{T} {z}_{j} ) \qquad ( 5 )$$

$${A}_{n} = \frac{n}{4} - \frac{1}{n π} {\sum }_{i} {Ψ}_{ij}$$

in which

When the term defined by the Σ symbol is interpreted for each of the Gine score and the Ajne score, in a case where two first residual normalized vectors are directed to the same direction, an angle ψᵢⱼ formed by the two first residual normalized vectors is a value close to 0, and therefore a value of the term defined by the Σ symbol of each of the Gine score and the Ajne score is a value close to 0. Meanwhile, in a case where two first residual normalized vectors are directed to different directions, an angle ψᵢⱼ formed by the two first residual normalized vectors is larger than 0, and therefore a value of the term defined by the 2 symbol of each of the Gine score and the Ajne score is a value larger than 0.

As described above, considering that a minus sign is attached before the term defined by the Σ symbol, each of the Gine score and the Ajne score has a large value in a case where distribution of the first residual normalized vectors is uniform on a circumference, a spherical surface, or a hyperspherical surface, and has a small value in a case where the distribution is biased.

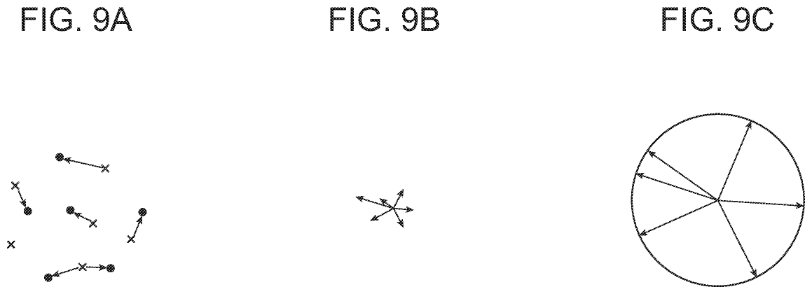

FIG. 9A is a conceptual diagram illustrating the first difference vector acquiring process performed by the change detecting device 100 according to the first embodiment, FIG. 9B is a diagram illustrating an example of the plurality of first difference vectors obtained by the first difference vector acquiring process performed by the change detecting device 100 according to the first embodiment, and FIG. 9C is a diagram illustrating an example of the plurality of first residual normalized vectors obtained by the first normalization process performed by the change detecting device 100 according to the first embodiment. FIGS. 9A, 9B, and 9C are different from FIGS. 8A, 8B, and 8C in that the time-series data acquired by the change detecting device 100 in the process in step ST2 is data in a case where there is no characteristic change between the first time-series data and the second time-series data.

As illustrated in FIGS. 9A, 9B, and 9C, when the change detecting device 100 performs the process using such time-series data, the directions of the acquired plurality of first difference vectors are less biased, and the acquired plurality of first residual normalized vectors are distributed on a circumference in a substantially uniform state.

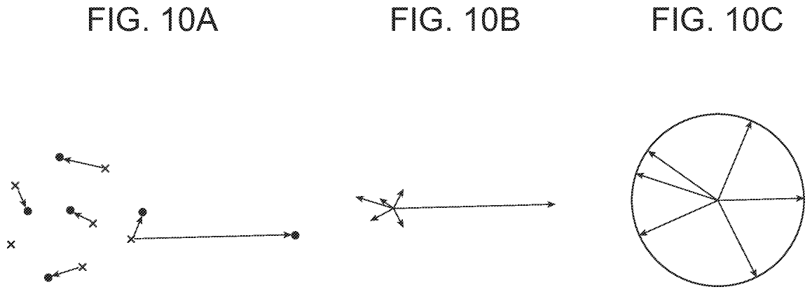

FIG. 10A is a conceptual diagram illustrating the first difference vector acquiring process performed by the change detecting device 100 according to the first embodiment, FIG. 10B is a diagram illustrating an example of the plurality of first difference vectors obtained by the first difference vector acquiring process performed by the change detecting device 100 according to the first embodiment, and FIG. 10C is a diagram illustrating an example of the plurality of first residual normalized vectors obtained by the first normalization process performed by the change detecting device 100 according to the first embodiment. FIGS. 10A, 10B, and 10C are different from FIGS. 8A, 8B, and 8C in that the time-series data acquired by the change detecting device 100 in the process in step ST2 includes a data value which is an outlier (singular value). Note that, in the present disclosure, the outlier means a data value in which a difference when simply compared with another data value is larger than a difference between other data values, and includes an abnormal value due to an artificial mistake in acquiring a data value, malfunction of a measuring instrument that acquires the data value, or the like.

As illustrated in FIGS. 10A and 10B, for example, in a case where a data value that is an outlier is included in the second time-series data acquired by the change detecting device 100, an outlier vector vₓ acquired on the basis of the outlier is included in the plurality of first vectors, and an outlier difference vector rₓ acquired on the basis of the outlier vector vₓ is included in the plurality of first difference vectors. However, as illustrated in FIG. 10C, the change detecting device 100 according to the first embodiment performs the first normalization process of normalizing each of the first difference vectors rᵢ, whereby the outlier difference vector rₓ is converted into a residual normalized vector having a size of 1. Therefore, an influence of the outlier difference vector rₓ on a calculation result can be suppressed.

As illustrated in FIG. 4, after performing the process in step ST6, the change detecting device 100 performs a second difference vector acquiring process of calculating a difference vector between the first vector and the second vector acquired in the vector acquiring process in step ST3 (step ST8). In the second difference vector acquiring process as a difference vector acquiring process, the change detecting device 100 subtracts a specific first vector vᵢ among the plurality of first vectors from a specific second vector v′ᵢ among the plurality of second vectors by the difference vector acquiring unit 22, and calculates a second difference vector r′ᵢ.

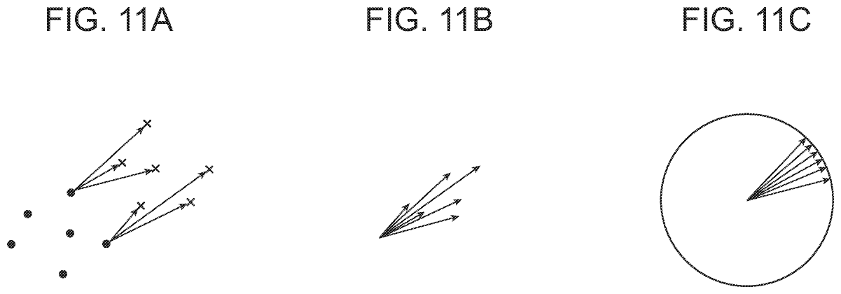

FIG. 11A is a conceptual diagram illustrating the second difference vector acquiring process performed by the change detecting device 100 according to the first embodiment. In FIG. 11A, a circle indicates a first vector, and X indicates a second vector. For example, in the second difference vector acquiring process, similarly to the process in step ST4, the change detecting device 100 performs, for each first vector, a process of extracting a second vector v′ᵢ closest to a specific first vector vᵢ by a k-nearest neighbor algorithm, and as expressed by Numerical Formula (6), subtracting the corresponding first vector vᵢ from the extracted second vector v′ᵢ, and calculates a second difference vector r′ᵢ, thereby acquiring a plurality of second difference vectors. Note that, in a case where k in the k-nearest neighbor algorithm is equal to or more than 2, the difference vector r′ᵢ is calculated using a first vector vᵢ^{(knn)} which is an average vector of vectors that are k-nearest neighbors.

$${r}_{i} = {v}_{i} - {v}_{i}^{′ ( knn )} ( i = 1 , 2 , … , n ) \qquad ( 6 )$$

$$Here , {v}_{i}^{( knn )} = \frac{1}{k} {\sum }_{j = 1}^{k} {v}_{i}^{′ ( j )}$$

in which

FIG. 11B is a diagram illustrating an example of the plurality of second difference vectors r′ᵢ obtained by the second difference vector acquiring process performed by the change detecting device 100 according to the first embodiment. Similarly to the plurality of first difference vectors rᵢ obtained by the first difference vector acquiring process in step ST4, the plurality of second difference vectors r′ᵢ obtained by the second difference vector acquiring process in step ST8 have different directions and sizes.

After performing the process in step ST8, the change detecting device 100 performs a second normalization process of normalizing each of the second difference vectors r′ᵢ calculated in the second difference vector acquiring process in step ST8 (step ST9). In the second normalization process as a normalization process, the change detecting device 100 acquires second residual normalized vectors as a plurality of residual normalized vectors by converting each of the second difference vectors r′ᵢ into a second residual normalized vector z′ᵢ by the vector converting unit 23 as illustrated in Numerical Formula (7). In other words, the change detecting device 100 makes the sizes of the second difference vectors uniform by the vector converting unit 23.

$${z}_{i}^{′} = {r}_{i}^{′} / ‖ {r}_{i}^{′} ‖ ( i = 1 , 2 , … , n ) \qquad ( 7 )$$

FIG. 11C is a diagram illustrating an example of a plurality of second residual normalized vectors z′ᵢ obtained by the second normalization process performed by the change detecting device 100 according to the first embodiment. The change detecting device 100 converts a plurality of second difference vectors r′ᵢ having the number of dimensions M of 2 into a plurality of second residual normalized vectors z′ᵢ having the number of dimensions M of 2 by the second normalization process. The plurality of second residual normalized vectors are distributed on a circumference having a radius of 1. Similarly to the first residual normalized vector, in a case where the number of dimensions M is 3, the plurality of second residual normalized vectors are distributed on a spherical surface, and in a case where the number of dimensions M is equal to or more than 4, the plurality of second residual normalized vectors are distributed on a hyperspherical surface.

After performing the process in step ST9, the change detecting device 100 performs a second change score calculating process of calculating a second change score on the basis of the plurality of second residual normalized vectors (step ST10). In the second change score calculating process as a change score calculating process, the change detecting device 100 calculates the second change score as a change score which is a value indicating a bias of distribution of the plurality of second residual normalized vectors by the change score calculating unit 24, thereby acquiring the second change score. For example, similarly to the first change score calculating process, the change detecting device 100 calculates a Rayleigh score R′ as the second change score by a known algorithm illustrated in Numerical Formula (8).

$$R = ‖ {\sum }_{i = 1}^{n} {Z}_{i}^{′} ‖ \qquad ( 8 )$$

$$( i = 1 , 2 , … , n )$$

After performing the process in step ST10, the change detecting device 100 performs a maximum change score calculating process of calculating a maximum value out of the first change score calculated in step ST6 and the second change score calculated in step ST10 (step ST11). In this process, the change detecting device 100 compares the calculated first change score with the calculated second change score, and selects one of the change scores which has a larger value. In other words, the change detecting device 100 selects a change score indicating that a change of the time-series data is the largest among the calculated change scores.

After performing the process in step ST11, the change detecting device 100 performs a change detecting process of detecting a change of the time-series data by comparing the value of the change score calculated in step ST11 with a threshold set in advance (step ST12). In this process, by the change detecting unit 25, the change detecting device 100 compares the value of the change score calculated in step ST11 with a threshold set in advance by the parameter setting unit 26, and determines that there is a characteristic change of the time-series data between the first time-series data and the second time-series data in a case where the value of the change score exceeds the threshold. In addition, in this process, by the change detecting unit 25, the change detecting device 100 compares the value of the change score calculated in step ST11 with a threshold set in advance by the parameter setting unit 26, and determines that there is no characteristic change of the time-series data between the first time-series data and the second time-series data in a case where the value of the change score is within the threshold.

For example, the change detecting device 100 acquires time-series data in a normal time without a characteristic change in advance, and sets a threshold on the basis of a change score in the normal time calculated on the basis of the time-series data in the normal time. Specifically, the change detecting device 100 may be configured to acquire time-series data in a normal time without a characteristic change in advance, and to set, as a threshold, a value obtained by adding a predetermined value to a change score in the normal time calculated on the basis of the time-series data in the normal time. In other words, the change detecting device 100 is configured in such a manner that the time-series data acquiring unit 10 acquires time-series data in a period including a third period which is a period before the first period and a fourth period which is a period between the third period and the first period, the vector acquiring unit 21 acquires a plurality of third vectors (first vectors) which are a plurality of pieces of partial time-series data in the third period and a plurality of fourth vectors (second vectors) which are a plurality of pieces of partial time-series data in the fourth period on the basis of the time-series data acquired by the time-series data acquiring unit 10, the difference vector acquiring unit 22 acquires a difference vector related to a combination of a specific third vector among the plurality of third vectors and a specific fourth vector among the plurality of fourth vectors in a plurality of combinations, and the parameter setting unit 26 as a threshold setting unit sets a threshold on the basis of a bias of distribution of directions of the plurality of difference vectors acquired by the difference vector acquiring unit 22. Note that the third vector in the third period corresponds to the first vector in the first period, the fourth vector in the fourth period corresponds to the second vector in the second period, and each of a difference between the first vector and the third vector and a difference between the second vector and the fourth vector is only a difference in the acquired periods.

Note that the change detecting device 100 may be configured to calculate a plurality of change scores in advance in a plurality of periods that are periods before the first period, and to set a threshold on the basis of the calculated plurality of change scores. For example, the change detecting device 100 may be configured to set, as a threshold, a value obtained by adding a predetermined value to a representative value such as an average value, a median value, or a maximum value of a plurality of change scores calculated in advance.

After performing the process in step ST12, the change detecting device 100 outputs a determination result as to whether there is a characteristic change of the time-series data, as a comparison result by the change detecting unit 25 (step ST13). For example, in this process, the change detecting device 100 causes the output unit 30 to display information corresponding to the determination result on a display device (not illustrated). In addition, for example, in this process, the change detecting device 100 transmits information corresponding to the determination result to an external device (not illustrated) by the output unit 30. After performing the process in step ST13, the change detecting device 100 ends the processes.

As described above, the change detecting device 100 in the first embodiment includes: the time-series data acquiring unit 10 that acquires time-series data in a period including a first period and a second period which is a period after the first period; the vector acquiring unit 21 that acquires a plurality of first vectors which are a plurality of pieces of partial time-series data in the first period and a plurality of second vectors which are a plurality of pieces of partial time-series data in the second period on the basis of the time-series data acquired by the time-series data acquiring unit 10; the difference vector acquiring unit 22 that acquires a difference vector related to a combination of a specific first vector among the plurality of first vectors and a specific second vector among the plurality of second vectors in a plurality of combinations; and the change detecting unit 25 that detects a characteristic change of the time-series data on the basis of a bias in distribution of directions of the plurality of difference vectors acquired by the difference vector acquiring unit 22.

As described above, the change detecting device 100 according to the first embodiment can suppress an influence of an outlier included in time-series data by detecting a characteristic change of the time-series data on the basis of a bias in directions of a plurality of difference vectors acquired on the basis of the time-series data without considering the sizes of the plurality of difference vectors, and can improve accuracy in detecting the characteristic change of the time-series data, that is, a change in a trend of the time-series data as compared with related art.

In addition, the change detecting device 100 according to the first embodiment has few restrictions on the length and the number of data of time-series data necessary for detecting a characteristic change of the time-series data, and thus can detect the characteristic change of the time-series data of a small number of data as compared with another change detection algorithm, for example, a KL-CPD method in which a kernel function necessary for detecting the change cannot be found in some cases when the number of data after the change is small.

In addition, the change detecting device 100 according to the first embodiment includes the vector converting unit 23 that acquires vectors obtained by converting the plurality of difference vectors acquired by the difference vector acquiring unit 22 in such a way as to have a uniform size without changing directions, and the change detecting unit 25 detects a characteristic change of the time-series data on the basis of a bias in distribution of directions of the vectors acquired by the vector converting unit 23.

The vector acquiring unit 21 according to the first embodiment acquires a plurality of first vectors by sliding a slide window in the time-series data in the first period, and acquires a plurality of second vectors by sliding the slide window in the time-series data in the second period.

The difference vector acquiring unit 22 according to the first exemplary embodiment extracts, for each of the plurality of first vectors, a closest second vector among the plurality of second vectors, and acquires a plurality of difference vectors on the basis of a difference between each of the plurality of first vectors and the extracted second vector.

In the change detecting device 100 according to the first embodiment, the plurality of difference vectors are a plurality of first difference vectors, the difference vector acquiring unit 22 extracts, for each of the plurality of second vectors, a closest first vector among the plurality of first vectors, and acquires a plurality of second difference vectors on the basis of a difference between each of the plurality of second vectors and the extracted first vector, and the change detecting unit 25 detects a characteristic change of the time-series data on the basis of a bias in distribution of directions of difference vectors having a larger bias in distribution of directions out of the plurality of first difference vectors and the plurality of second difference vectors acquired by the difference vector acquiring unit 22.

The change detecting device 100 according to the first embodiment includes the change score calculating unit 24 that calculates a change score corresponding to a bias in distribution of directions of the plurality of difference vectors, and the change detecting unit 25 detects a characteristic change of the time-series data on the basis of whether or not the change score calculated by the change score calculating unit 24 exceeds a threshold set in advance.

The change detecting device 100 according to the first embodiment includes the parameter setting unit 26 that sets the threshold, the time-series data includes a third period which is a period before the first period and a fourth period which is a period between the third period and the first period, the vector acquiring unit acquires a plurality of third vectors which are a plurality of pieces of partial time-series data in the third period and a plurality of fourth vectors which are a plurality of pieces of partial time-series data in the fourth period on the basis of the time-series data acquired by the time-series data acquiring unit, the difference vector acquiring unit 22 acquires a difference vector related to a combination of a specific third vector among the plurality of third vectors and a specific fourth vector among the plurality of fourth vectors in a plurality of combinations, and the parameter setting unit 26 sets the threshold on the basis of a bias of distribution of directions of the plurality of difference vectors acquired by the difference vector acquiring unit 22.

Note that, in the first embodiment, the change detecting device 100 is configured to detect a characteristic change of the time-series data by comparing the change score calculated by the change score calculating unit 24 with the threshold set in advance, but it is not limited thereto. The change detecting device only needs to be configured to detect a characteristic change of the time-series data on the basis of the change score, and may be configured to detect the characteristic change of the time-series data on the basis of, for example, a time change amount of the change score or a time change rate of the change score.

In the first embodiment, the change detecting device 100 acquires the plurality of first vectors and the plurality of second vectors with the number of dimensions M of the vector acquired in the vector acquiring process set to 2 and the number of slides set to 1, but it is not limited thereto. The change detecting device 100 may be configured to appropriately set the number of dimensions M of the vector and the number of slides by the parameter setting unit 26.

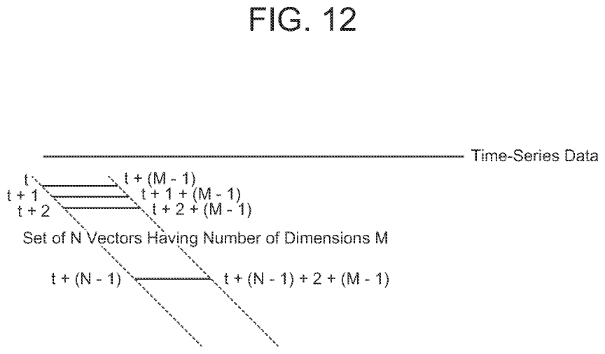

FIG. 12 is a conceptual diagram illustrating the vector acquiring process performed by the change detecting device 100 according to the first embodiment. As illustrated in FIG. 12, the change detecting device 100 acquires a set of N vectors having the number of dimensions M from time-series data having a predetermined length. Note that FIG. 12 illustrates an example of a case where the number of slides is 1 when the change detecting device 100 acquires a set of N vectors having the number of dimensions M, but the number of slides may be other than 1 as described above. For example, the parameter setting unit 26 may be configured to set the number of slides on the basis of the time-series data acquired by the time-series data acquiring unit 10. Specifically, the parameter setting unit 26 may be configured to set the number of slides to be relatively small in a case where the time-series data acquired by the time-series data acquiring unit 10 is time-series data having a large variation in a short time relatively. In addition, the parameter setting unit 26 may be configured to set the number of slides to be relatively large in a case where the time-series data acquired by the time-series data acquiring unit 10 is time-series data having a small variation in a short time relatively. In addition, the parameter setting unit 26 may be configured to dynamically change the number of slides by observing a change of the time-series data.

The parameter setting unit 26 may be configured to appropriately set also a slide window length which is the number of dimensions M of each of the first vector and the second vector acquired by the vector acquiring unit 21. However, when the difference vector acquiring unit 22 calculates a difference vector, the number of dimensions of the first vector needs to coincide with the number of dimensions of the second vector. In a case where the length of the time-series data acquired by the time-series data acquiring unit 10 is longer than a period obtained by summing up the first period and the second period, the change detecting device 100 may set various parameters to new values after performing the processes in steps ST2 to ST13 illustrated in FIG. 4, and may perform the processes in steps ST2 to ST13 again.

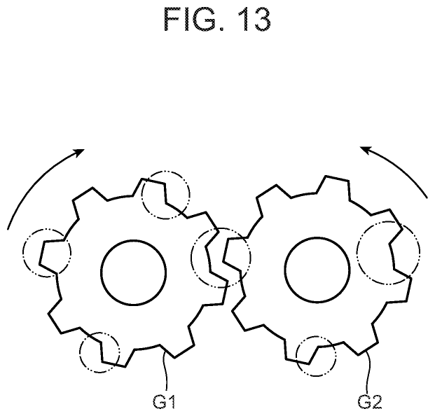

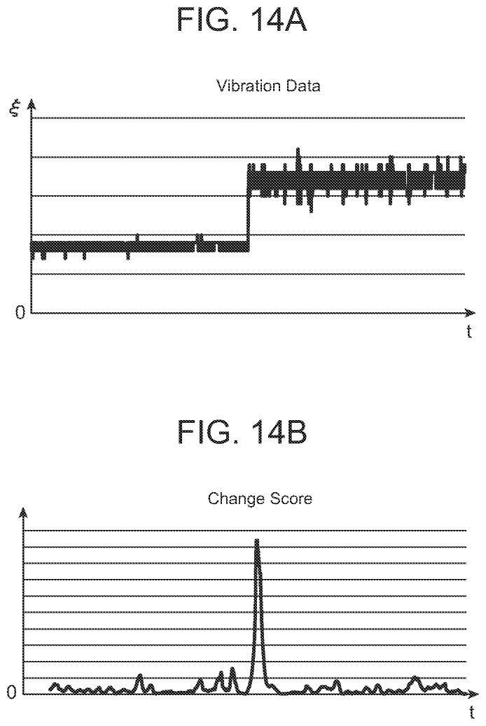

Next, a specific example of detecting a characteristic change of time-series data using the change detecting device 100 according to the first embodiment will be described with reference to FIGS. 13 to 16. First, an example of detecting a characteristic change of vibration data of a timing gear using the change detecting device 100 according to the first embodiment will be described with reference to FIGS. 13 and 14. FIG. 13 is a schematic diagram illustrating timing gears G1 and G2 of which a change of vibration is detected by the change detecting device 100 according to the first embodiment, FIG. 14A is a graph illustrating vibration data of the timing gears G1 and G2 as time-series data acquired by the change detecting device 100 according to the first embodiment, and FIG. 14B is a graph illustrating a change score calculated by the change detecting device 100 according to the first embodiment on the basis of the vibration data of the timing gears G1 and G2.

In general, in a timing gear, vibration of the timing gear changes due to occurrence of a change such as wear, scratch, lack, or adhesion of foreign matters. Therefore, by detecting a characteristic change of the vibration data of the timing gear, it is possible to detect these changes related to the timing gear.

The graph illustrated in FIG. 14A is, for example, vibration data indicating a vibration level acquired by a vibration sensor from the timing gears G1 and G2 at a cycle of one second. The graph illustrated in FIG. 14B is a transition of a change score calculated by setting the number of dimensions M of each of the first vector and the second vector to 10 using the vibration data of the timing gears G1 and G2. In FIG. 14B, it can be seen that a value of the change score also changes to increase at a time when the vibration data changes.

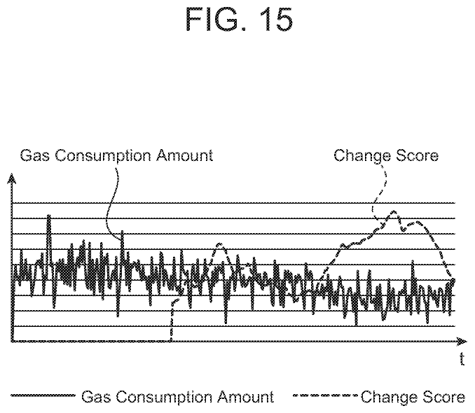

Next, an example of detecting a characteristic change of a gas consumption amount of a specific consumer using the change detecting device 100 according to the first embodiment will be described with reference to FIG. 15. FIG. 15 is a graph illustrating gas consumption amount data as time-series data acquired by the change detecting device 100 according to the first embodiment and a change score calculated on the basis of the gas consumption amount data. The graph of a change score illustrated in FIG. 15 is a transition of a change score calculated by setting the number of dimensions M of each of the first vector and the second vector to 10. In FIG. 15, the vertical axis represents a gas consumption amount expressed in cubic meters, the change score is a dimensionless number expressed from 0 to 1, and scales of both are common.

In general, the gas consumption amount changes with a change of the number of consumers (family structure), a change of gas consumption equipment such as introduction of a new gas device, a change of living style, a change of temperature, or the like. As illustrated in FIG. 15, when the change detecting device 100 acquires data of a gas consumption amount of a consumer in a predetermined period as time-series data, it can be seen that the gas consumption amount changes during the Golden Week holidays and the Bon holidays, and a value of the change score changes to increase during the same periods.

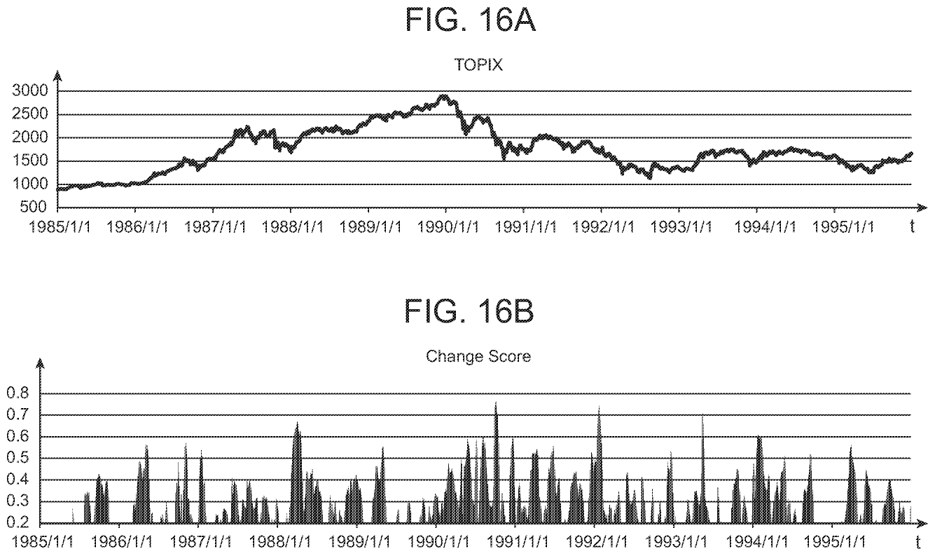

Next, an example of detecting a characteristic change of a stock index using the change detecting device 100 according to the first embodiment will be described with reference to FIG. 16. FIG. 16A is a graph illustrating a transition of a daily closing price of a TSE stock price index (TOPIX) as time-series data acquired by the change detecting device 100 according to the first embodiment, and FIG. 16B is a graph illustrating a change score calculated by the change detecting device 100 according to the first embodiment on the basis of data of the TSE stock price index. In addition, the graph of a change score illustrated in FIG. 16 is a transition of a change score calculated by setting the number of dimensions M of each of the first vector and the second vector to 10.

In general, a period called a bubble economy is said to be a period from December 1986 to February 1991. In conventional stock price research, a variation (volatility and degree of difference) often attracts attention. However, as illustrated in FIGS. 16A and 16B, it can be seen that the magnitude of the variation and the change score do not necessarily coincide with each other. According to the change detecting device 100 according to the first embodiment, as illustrated in FIG. 16B, the change score changes to increase on Nov. 5, 1986 and Dec. 20, 1990, and it is possible to detect a change of the stock index earlier than a timing generally called a beginning of the bubble economy and to detect the change of the stock index earlier than a timing generally called an end of the bubble economy.

Note that, in the present disclosure, any component in the embodiment can be modified, or any component can be omitted.

### REFERENCE SIGNS LIST

10: time-series data acquiring unit, 20: calculation unit, 21: vector acquiring unit, 22: difference vector acquiring unit, 23: vector converting unit, 24: change score calculating unit, 25: change detecting unit, 26: parameter setting unit (threshold setting unit), 30: output unit, 100: change detecting device

1. A change detecting device comprising:
a time-series data acquiring unit to acquire time-series data in a period including a first period and a second period which is a period after the first period;
a vector acquiring unit to acquire a plurality of first vectors which are a plurality of pieces of partial time-series data in the first period and a plurality of second vectors which are a plurality of pieces of partial time-series data in the second period on a basis of the time-series data acquired by the time-series data acquiring unit;
a difference vector acquiring unit to acquire a difference vector related to a combination of a specific first vector among the plurality of first vectors and a specific second vector among the plurality of second vectors in a plurality of combinations; and
a change detecting unit to detect a characteristic change of the time-series data on a basis of a bias in distribution of directions of the plurality of difference vectors acquired by the difference vector acquiring unit.

2. The change detecting device according to claim 1, comprising a vector converting unit to acquire vectors obtained by converting the plurality of difference vectors acquired by the difference vector acquiring unit in such a way as to have a uniform size without changing directions, wherein
the change detecting unit detects a characteristic change of the time-series data on a basis of a bias in distribution of directions of the vectors acquired by the vector converting unit.

3. The change detecting device according to claim 1, wherein
the vector acquiring unit acquires the plurality of first vectors by sliding a slide window in the time-series data in the first period, and acquires the plurality of second vectors by sliding the slide window in the time-series data in the second period.

4. The change detecting device according to claim 1, wherein
the difference vector acquiring unit extracts, for each of the plurality of first vectors, a closest second vector among the plurality of second vectors, and acquires the plurality of difference vectors on a basis of a difference between each of the plurality of first vectors and the extracted second vector.

5. The change detecting device according to claim 4, wherein
the plurality of difference vectors are a plurality of first difference vectors,
the difference vector acquiring unit extracts, for each of the plurality of second vectors, a closest first vector among the plurality of first vectors, and acquires a plurality of second difference vectors on a basis of a difference between each of the plurality of second vectors and the extracted first vector, and
the change detecting unit detects a characteristic change of the time-series data on a basis of a bias in distribution of directions of difference vectors having a larger bias in distribution of directions out of the plurality of first difference vectors and the plurality of second difference vectors acquired by the difference vector acquiring unit.

6. The change detecting device according to claim 1, comprising a change score calculating unit to calculate a change score corresponding to a bias in distribution of directions of the plurality of difference vectors, wherein
the change detecting unit detects a characteristic change of the time-series data on a basis of whether or not the change score calculated by the change score calculating unit exceeds a threshold set in advance.

7. The change detecting device according to claim 6, comprising a threshold setting unit to set the threshold, wherein
the time-series data includes a third period which is a period before the first period and a fourth period which is a period between the third period and the first period,
the vector acquiring unit acquires a plurality of third vectors which are a plurality of pieces of partial time-series data in the third period and a plurality of fourth vectors which are a plurality of pieces of partial time-series data in the fourth period on a basis of the time-series data acquired by the time-series data acquiring unit,
the difference vector acquiring unit acquires a difference vector related to a combination of a specific third vector among the plurality of third vectors and a specific fourth vector among the plurality of fourth vectors in a plurality of combinations, and
the threshold setting unit sets the threshold on a basis of a bias in distribution of directions of the plurality of difference vectors acquired by the difference vector acquiring unit.

8. The change detecting device according to claim 1, wherein
the time-series data acquiring unit acquires data of a gas consumption amount in a predetermined period as the time-series data, and
the change detecting unit detects a characteristic temporal change of the gas consumption amount on a basis of a bias in directions of the difference vectors acquired by the difference vector acquiring unit.

9. A change detecting method performed by a device including a time-series data acquiring unit, a vector acquiring unit, a difference vector acquiring unit, and a change detecting unit, the method comprising:
acquiring, by the time-series data acquiring unit, time-series data in a period including a first period and a second period which is a period after the first period;
acquiring, by the vector acquiring unit, a plurality of first vectors which are a plurality of pieces of partial time-series data in the first period and a plurality of second vectors which are a plurality of pieces of partial time-series data in the second period on a basis of the time-series data acquired by the time-series data acquiring unit;
acquiring, by the difference vector acquiring unit, a difference vector related to a combination of a specific first vector among the plurality of first vectors and a specific second vector among the plurality of second vectors in a plurality of combinations; and
detecting, by the change detecting unit, a characteristic change of the time-series data on a basis of a bias in distribution of directions of the plurality of difference vectors acquired by the difference vector acquiring unit.
